(19) United States
(12) Patent Application Publication
(10) Pub. No.: US 2018/0323641 A1
(43) Pub. Date: Nov. 8, 2018

(54) PORTABLE POWER SUPPLY

(71) Applicant: TTI (MACAO COMMERCIAL OFFSHORE) LIMITED, Macau (MO)

(72) Inventors: Hei Man Raymond LEE, KwaiChung (HK); Yong Min LI, Dongguan City (CN)

(21) Appl. No.: 15/974,525

(22) Filed: May 8, 2018

(30) Foreign Application Priority Data
May 8, 2017 (CN) 201720500896.9

(51) Int. Cl. H02J 9/06; H01M 2/10; H02J 7/00; H02J 7/04

(52) U.S. Cl. CPC H02J 9/061; H01M 2/1005; H02J 9/062; H01M 2/1022; B25F 5/02; H02J 7/0026; H02J 7/04; H02J 7/0054; H02J 7/0065; H02J 7/0042

(57) ABSTRACT

A portable power supply assembly for power tool, the power supply operated on AC mains having a mains input comprises an AC-to-DC converter coupled between the mains input and a rechargeable battery unit, a DC-to-DC converter, wherein the rechargeable battery unit couples to an input of the DC-to-DC converter, a power inverter for converting direct current (DC) into alternating current (AC), a housing for enclosing the AC-to-DC converter, the rechargeable battery unit, the DC-to-DC converter and the power inverter, an AC outlet disposed on the housing. The rechargeable battery unit is connected between the AC-to-DC converter and the power inverter, a first-voltage DC power converted from the AC mains via the AC-to-DC converter is stored in the rechargeable battery unit, thereby supplies the first-voltage DC power to the power inverter and such that in use, the first-voltage DC power from the rechargeable battery unit is converted to AC output available at the AC outlet of the power supply by the power inverter.

### CROSS-REFERENCE TO RELATED APPLICATIONS

This application claims foreign priority to Chinese Patent Application No. 201720500896.9 filed May 8, 2017, the entire contents of which are hereby incorporated herein.

### FIELD OF INVENTION

The present invention relates to a portable power supply comprising a mobile AC power supply for AC power tools and a charger for charging DC battery packs.

### BACKGROUND OF THE INVENTION

In many situations, for example on a construction jobsite which is not yet connected to the mains electricity supply, there is a need to provide electrical power to electrically operated equipment where mains electricity is not available. Accordingly, many construction workers rely on portable generators that can supply power to their power tools.

Typical portable generators, however, may be too heavy and/or may generate an insufficient amount of power. For example, a single worker may be required to transport a portable power supply around a construction site and possibly between levels of a building (e.g., via a ladder). As the power generation of a portable power supply increases, however, the weight also increases. Specifically, larger generating devices (e.g., engines/alternators) may be required to provide adequate power to the point of use.

To overcome the above drawback of limited mobility by the prior fuel driven generator, portable power supply runs on electricity is also available in this field. Such portable power supply is featured by having AC-to-DC converter and DC-to-AC inverter and charging function via providing a built-in charger for charging rechargeable battery unit used in DC power tools. Such power supply however is generally designed stop running when mains electricity supply is disconnected.

FIG. 1 illustrates a portable alternating current (AC) power supply 100 according to the prior art. Specifically, the portable AC power supply 100 includes an AC-to-direct current (DC) converter 102 and a DC-to-AC inverter 103. The AC-to-DC converter 102 provides DC power to the DC-to-AC inverter 103 for converting the DC power to an AC output voltage for supplying AC output to AC power tools. This prior power supply 100 may further include DC output ports (not shown) for receiving and charging rechargeable battery cells for use in DC power tools.

### SUMMARY OF THE INVENTION

In the above account, it is an object of the at least one embodiment of the present invention to provide a power supply comprising an AC-to-DC converter and a power inverter for converting direct current (DC) into alternating current (AC), for providing AC power to AC driven electric power tool, no matter whether AC mains electricity is available or not to supply primary AC power to the power supply.

Accordingly, the present invention in one aspect is a portable power supply operated on AC mains having a mains input comprises an AC-to-DC converter coupled between the mains input and a rechargeable battery unit coupled to a DC-to-DC converter, a power inverter for converting direct current (DC) into alternating current (AC). The power supply further includes a housing to enclose the AC-to-DC converter, the rechargeable battery unit, the DC-to-DC converter and the power inverter. The rechargeable battery unit is connected between the AC-to-DC converter and the power inverter, and the AC-to-DC converter converts AC power from AC mains to a first-voltage DC power which is then stored in the rechargeable battery unit, thereby supplies the first-voltage DC power to the power inverter and such that in use, the first-voltage DC power from the rechargeable battery unit is converted to AC output from the power supply assembly by the power converter.

In an exemplary embodiment of the present invention, the DC-to-DC converter is bi-directional and converts the first-voltage DC power (48V-300V) to a second-voltage DC power (12V-60V) for charging one or more battery packs.

In another exemplary embodiment of the present invention, the power supply is operable and switchable between a normal DC operation mode in which the first-voltage DC power is supplied to the bi-directional DC-to-DC converter converting the first-voltage DC power to the second-voltage DC power for charging the one or more battery packs, and a discharging mode in which the second-voltage DC power stored in the one or more battery packs and the first-voltage DC power stored in the rechargeable battery unit are released to an AC load connected to the power inverter.

In further exemplary embodiment, the power supply is configured to the discharging mode when the AC load is connected to the power inverter or to the normal DC operation mode when the AC load is not connected to the power inverter.

In yet further exemplary embodiment of the present invention, the AC-to-DC converter is a DC charger for charging the rechargeable battery unit.

In another exemplary embodiment of the present invention, the housing includes first DC outlet for connecting to DC load and supplying the first-voltage DC power from the rechargeable battery unit to the DC load. Preferably, the DC load is DC power tool.

In yet another exemplary embodiment of the present invention, the housing includes second DC outlet for connecting to other electric device and supplying the first-voltage DC power from the AC-to-DC converter to said other electric device. Preferably the other electric device is portable electronic device, such as mobile phones.

In another embodiment of the present invention the housing further includes AC outlet for connecting to AC load and supplying the AC output from the power inverter to the AC load. Preferably, the AC load is AC power tool.

In still further another implementation, the housing further includes DC output port for receiving and charging further rechargeable battery packs external to the power supply by the second-voltage DC power from the DC-to-DC converter.

Preferably, the rechargeable battery unit has a voltage within a range from 48 Vdc to 300 Vdc, and more preferably 60 Vdc.

Preferably, the rechargeable battery unit is of a capacity within a range of 0.1 kwh to 10 kwh.

In another implementation, the one or more battery packs have a voltage within a range from 12 Vdc to 60 Vdc.

In yet another implementation, the rechargeable battery unit is removably connected between the AC-to-DC converter and the power inverter.

In another aspect the present invention provides a kit comprising the above-mentioned portable power supply, together with one or more rechargeable battery packs, preferably the one or more rechargeable battery packs have voltage within a range from 12 Vdc to 60 Vdc, and more preferably are used in DC power tools.

In the third aspect the present invention provides a portable direct current (DC) power supply operated on AC mains having a mains input, wherein the power supply comprises an AC-to-DC converter coupled between the mains input and a rechargeable battery unit, a DC-to-DC converter coupled to the rechargeable battery unit, a housing for enclosing the AC-to-DC converter the rechargeable battery unit and the DC-to-DC converter, and a DC output terminal disposed on the housing outputting first-voltage DC power from the rechargeable battery unit, wherein the DC output terminal is connectable to a detachable DC-to-AC power inverter and supplies the first-voltage DC power to the power inverter and such that in use when the DC-to-AC power inverter is connected to the DC power supply, the first-voltage DC power from the DC output terminal is converted to AC output via the external power inverter.

In one implementation of the third aspect of present invention, the DC-to-DC converter is bi-directional and converts the first-voltage DC power (48V-300V) to a second-voltage DC power (12V-60V) for charging one or more battery packs.

In another implementation of the second aspect of present invention, the power supply is operable and switchable between a normal DC operation mode in which the first-voltage DC power is supplied to the bi-directional DC-to-DC converter converting the first-voltage DC power to the second-voltage DC power for charging the one or more battery packs, and a discharging mode in which the second-voltage DC power stored in the one or more battery packs and the first-voltage DC power stored in the rechargeable battery unit are released to an AC load connected to the detachable DC-to-AC power inverter connected to the DC output terminal.

In still another implementation of the third aspect of present invention, the power supply is configured to the discharging mode when the AC load is connected to the detachable DC-to-AC power inverter connected to the DC output terminal.

In still further implementation of the third aspect of present invention, the power supply is configured to the normal DC operation mode when the AC load is not connected to the detachable DC-to-AC power inverter connected to the DC output terminal.

In yet another implementation, the AC-to-DC converter is a DC charger for charging the rechargeable battery unit.

In another exemplary embodiment of the DC power supply of the present invention, the housing includes first DC outlet for connecting to DC load and supplying the first-voltage DC power from the rechargeable battery unit to the DC load. Preferably, the DC load is DC power tool.

In yet another exemplary embodiment the DC power supply of the present invention, the housing includes further second DC outlet for connecting to other electric device and supplying the first-voltage DC power from the AC-to-DC converter to said other electric device. Preferably the other electric device is portable electronic device.

In still further another implementation, the housing further includes DC output port for receiving and charging further one or more battery packs external to the power supply assembly by the second-voltage DC power from the DC-to-DC converter.

In another implementation, the rechargeable battery unit has a voltage within a range from 48 Vdc to 300 Vdc, and preferably 60 Vdc. Preferably, the rechargeable battery unit is of a capacity within a range of 0.1 kwh to 10 kwh.

In yet another implementation, the one or more battery packs have a voltage within a range from 12 Vdc to 60 Vdc.

More preferably, the rechargeable battery unit is removably connected between the AC-to-DC converter and the DC output terminal.

In yet another aspect the present invention provides a kit comprising the above-mentioned DC power supply, together with one or more rechargeable battery packs, preferably the one or more rechargeable battery packs have a voltage within a range from 12 Vdc to 60 Vdc, and more preferably are used in DC power tools.

In this embodiment of present invention, the kit further comprises a detachable DC-to-AC converter.

Compared with the prior art it is therefore an object of the present invention to provide reliable and continuous power supply, which runs on electricity, for supplying power to a range of power tools. The present invention makes use of energy storage means to maintain a smooth and continuous power flow to the load. Specifically the power supply of the present invention provides standby power to the power tool in case of AC mains power outage. It is also an object of the present invention to optimize the utility of portable power supply when compared with the conventional type, when mobility of power supply is strongly required in jobsite.

Those skilled in the art will appreciate that the invention described herein is susceptible to variations and modifications other than those specifically described. The invention includes all such variations and modifications. The invention also includes all steps and features referred to or indicated in the specification, individually or collectively, and any and all combinations of the steps or features.

Other features and aspects of the invention will become apparent by consideration of the following detailed description and accompanying drawings.

### BRIEF DESCRIPTION OF THE DRAWINGS

FIG. 1 is a functional block diagram of a portable alternating current (AC) power supply according to the prior art.

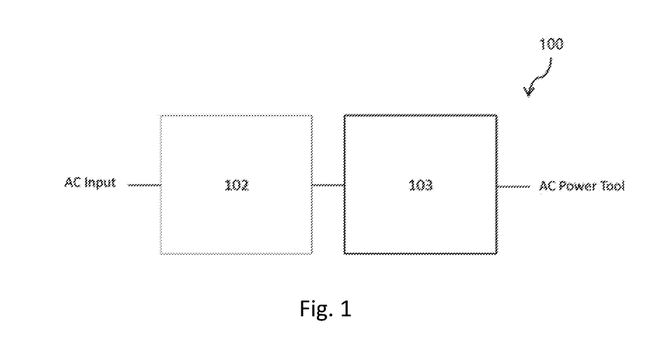

FIG. 2a is a functional block diagram of a power supply assembly according to one implementation of the present invention.

FIG. 2b includes a perspective view of a power supply assembly and DC batteries for use in DC power tools according to the implementation of the present invention as illustrated in FIG. 2a.

FIG. 3a is a functional block diagram of a DC power supply according to one implementation of the present invention.

FIG. 3b includes a perspective view of a DC power supply and DC batteries for use in DC power tools according to the implementation of the present invention as illustrated in FIG. 3a.

### DETAILED DESCRIPTION OF THE INVENTION

Unless otherwise defined, all technical terms used herein have the same meaning as commonly understood by one skilled in the art to which the invention belongs.

As used herein, “comprising” means including the following elements but not excluding others. “Essentially consisting of” means that the material consists of the respective element along with usually and unavoidable impurities such as side products and components usually resulting from the respective preparation or method for obtaining the material such as traces of further components or solvents. “Consisting of” means that the material solely consists of, i.e. is formed by the respective element. As used herein, the forms “a,” “an,” and “the,” are intended to include the singular and plural forms unless the context clearly indicates otherwise.

The present invention is directed to a portable power supply comprising a AC-to-DC converter coupled to a rechargeable battery unit and an inverter for converting the direct current (DC) output from the rechargeable battery unit into alternative current (AC). Specifically, the AC-to-DC converter converts AC power from the AC mains to DC power and the DC power supplies to the rechargeable battery unit for storing the DC power. The output terminal of the rechargeable battery unit is connected to the input terminal of the inverter, and thereby the DC power stored in the rechargeable battery is to be converted to a rated AC power.

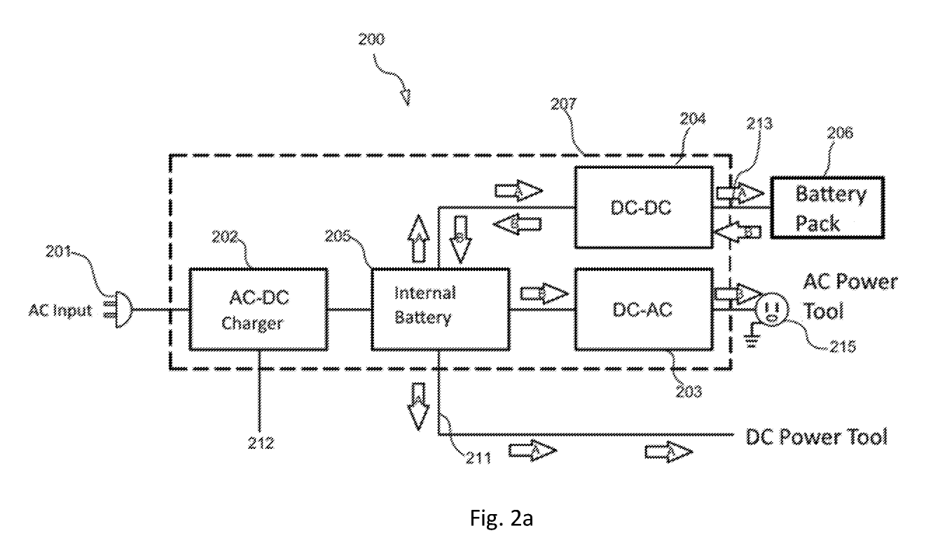

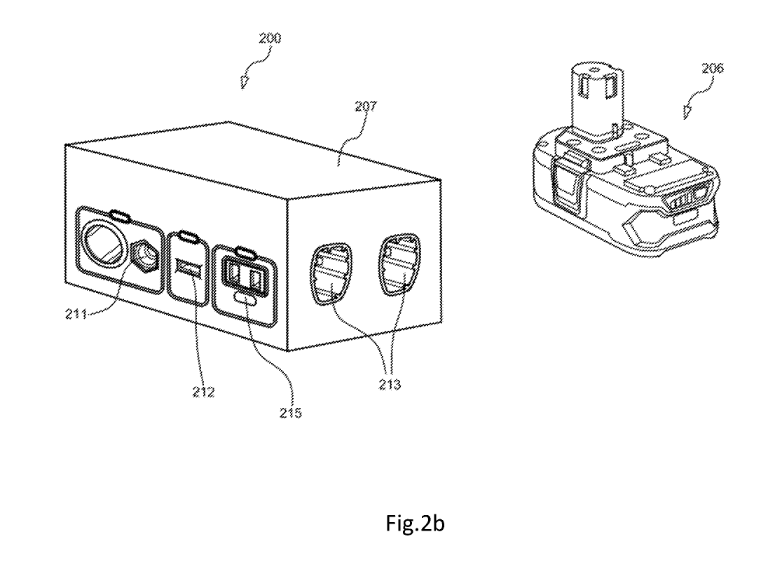

In FIG. 2a an exemplary portable power supply 200 according to the present invention is designated generally by the reference numeral 200. The portable power supply 200 operated on AC mains having a mains input 201 comprises an AC-to-DC converter 202 coupled between the mains input and a built-in rechargeable battery unit 205. The AC-to-DC converter 202 is a charger for charging the rechargeable battery unit 205 by converting the AC mains having 110 Vac, 220 Vac or 380 Vac and 50/60 Hz to a first-voltage DC power to be stored in the battery unit 205. The battery unit 205 has a voltage within the range from 48 Vdc to 300 Vdc. Preferably the rechargeable battery unit 205 has a voltage of 48 Vdc, and more preferably 60 Vdc. The power supply 200 further comprises a DC-to-DC converter 204 and the rechargeable battery unit 205 couples to an input of the DC-to-DC converter 204. The DC-to-DC converter 204 operates as a charger for charging one or more battery packs 206 external to the power supply 200. The power supply assembly 200 still further includes a DC-to-AC power inverter 203 where its input couples to the built-in rechargeable battery unit 205. The power supply assembly 200 further includes a housing 207 to enclose the AC-to-DC converter 202, the DC-to-DC converter 204, the rechargeable battery unit 205 and the power inverter 203. Specifically, the power supply 200 may include a controller (not shown) which enables charging of the battery unit 205 when a charge level of the battery unit 205 is less than a threshold. Similarly, the controller may disable charging of the battery unit 205 when the charge level of the battery unit 205 is greater than a threshold to prevent overcharging.

The first-voltage DC power stored in the rechargeable battery unit 205 is within a range of 0.1 kwh to 10 kwh and to be converted to AC power of 230 Vac or 110 Vac at 50 Hz by the power inverter 203, which in turn is provided to an AC load such as a 2 kW AC power tool or other devices running on AC power. Accordingly, the power supply 200 is designed to allow a user to have high AC power output from the power supply 200 while using battery unit 205 which has a safe voltage.

It is also an advantage for the present invention of the power supply 200 to provide continuous power to AC devices, or AC loads, when the primary AC power source, or mains, fails.

More specifically, the power supply 200 of the present invention further provides DC outlets/output ports and AC outlets for connecting and providing power to electric applications such as DC/AC electric tools and other electronic devices depending on the type of the power source required by the applications. The converters 202 and 204 work together (under command of the controller, not shown) to condition the supply provided to DC/AC loads via the DC/AC outlets. The controller receives various current and voltage measurements from different parts of the circuit, in order to perform its function. The skilled reader is familiar with these requirements and they will not be described further herein. The power supply 200 is configured via the controller to an operation mode suitable for the above-mentioned applications (i.e. providing power to DC/AC loads or charging battery packs 206).

In this embodiment, the DC-to-DC converter 204 is a bi-directional dc-dc converter capable of transferring DC electrical energy in either direction (i.e. to or from the DC power pack 206) on power bus. Specifically, the power supply 200 is set in normal DC operation mode when no AC load being connected to the power supply is detected. In the normal DC operation mode, the power supply 200 provides forward parallel path for the charges flowing from the built-in battery unit 205 to the DC-to-DC converters 204—DC power pack 206 branch and to the DC power tool branch, as illustrated in FIG. 2a path A. In this mode, the DC-to-DC converter 204 converts the first-voltage DC power from the rechargeable battery unit 205 to a second-voltage DC power to be stored in the DC power pack 206 external to the power supply 200. The second-voltage DC power is stored in the one or more DC power packs 206 having a voltage ranged from 12 Vdc to 60 Vdc and the one or more DC power packs 206 are suitable for use in battery driven or cordless DC power tools. In this mode, the battery unit 205 can also be a DC power source for powering up DC electric power tool when the DC electric power tool is connected to the DC outlet 211.

On the other hand, as shown in FIG. 2a path B when the AC power tool is connected to the AC outlet 215, the power supply 200 is automatically switched from normal DC operation mode to discharging mode allowing the AC output from the DC-to-AC power inverter 203 to power up AC electric power tool. In this discharging mode, the power supply 200 is configured to provide a reversed series path (thereby disable the forward path of charging the DC power pack 206 and driving the DC power tool) for current to leave the DC power pack 206 (if it is connected to the power supply 200) and the rechargeable battery unit 205 via the DC-to-DC converter 204 and the DC-to-AC power inverter 203 respectively, and thereby combines the currents to energize the AC electric power tool. The power supply 200 is configured to the discharging mode when the AC power tool is connected the power supply 200, or to the normal DC operation mode when the AC power tool is not connected to the power supply, regardless of the presence of the DC power tool connecting to the power supply. Therefore the AC electric power tool is prioritized to draw combined DC power of the first-voltage DC power from the rechargeable battery unit 205 and the second-voltage DC power from the DC power pack 206 to the DC-to-AC inverter 203 generating the AC output for powering up the AC power tool.

The controller is configured to control the operation mode as described above, based on detecting presence of the AC load, such that the converter 204 is selectively operable to generate and/or condition DC power at DC load ports or condition AC output at AC load port.

In another exemplary power supply 200 according to the present invention as shown in FIG. 2b, the housing 207 of the power supply 200 includes a first DC outlet 211 for connecting to corded DC power tool and supplying the first-voltage DC power from the rechargeable battery unit 205 to the corded DC power tool. The DC power tool may be a sander, table saw, miter saw, jig saw, angle grinder, electric router, electric hammer, drill, etc. Of course other electric tools can also be used, but are not described in detail due to limit of the text.

In yet another exemplary power supply assembly 200, the housing 207 further includes a second DC outlet 212 such as USB port for connecting to other electric device and supplying the first-voltage DC power from the AC-to-DC converter 202 to the other electric device. The other electric device may include but not limited to the portable/handheld electronic devices, tablets, laptop, smartphone, etc.

In still further exemplary power supply 200, the housing 207 further includes DC output port 213 for receiving and charging one or more rechargeable battery packs 206 by the second-voltage DC power from the DC-to-DC converter 204.

As illustrated in FIGS. 2a and 2b, in an exemplary power supply 200 according to the present invention, the housing 207 includes the AC outlet 215 for connecting to AC power tool (not shown) and supplying AC output from the power inverter 203 to the corded AC power tool.

The rechargeable battery unit 205 may be hard-wiredly coupled between the AC-to-DC converter 202 and the power inverter 203 or the battery unit 205 may be removably connected to both the AC-to-DC converter 202 and the power inverter 203. Advantageously, if the battery unit 205 becomes exhausted and no longer keeps its charge, it can be readily replaced by a new one when the battery unit 205 is removably connected to the AC-to-DC converter 202 and the power inverter 203.

In a further aspect of the present invention, it provides a kit that includes the power supply assembly 200 and one or more DC power packs 206 which can be recharged by the power supply assembly 200. Preferably the DC power packs 206 are for use in the DC power tools. The DC power tool may be a sander, table saw, miter saw, jig saw, angle grinder, electric router, electric hammer, drill, etc. Of course other electric tools can also be used, but are not described in detail due to limit of the text. This kit provides power source to corded/cordless DC power tools or AC power tools.

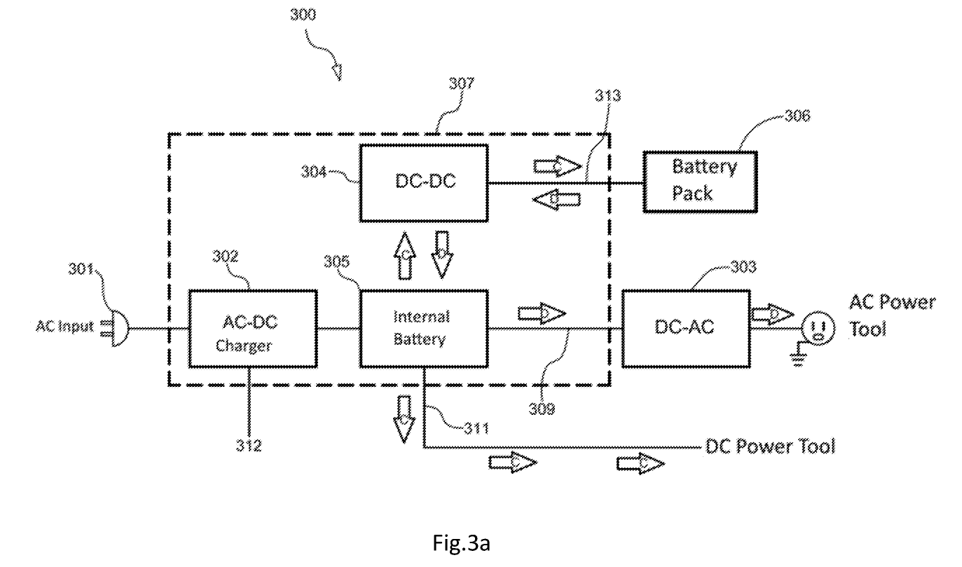

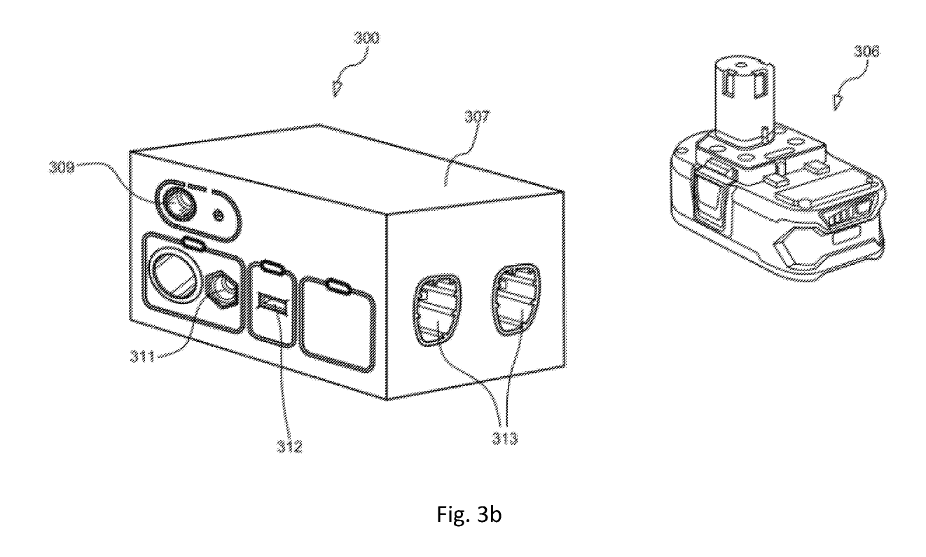

FIGS. 3a and 3b illustrate a power supply 300 according to another embodiment of the invention. The portable power supply 300 is similar to the power supply 200; therefore, like components have been given like reference numbers plus 100 and only differences between the power supply 200 and 300 will be discussed in detail. In addition, components or features described with respect to only one or some of the embodiments described herein are equally applicable to any other embodiments described herein.

The portable DC power supply 300 operated on AC mains having a mains input 301 comprises an AC-to-DC converter 302 coupled between the mains input and a built-in rechargeable battery unit 305, both of which are enclosed within a housing 307. The DC power supply 300 receives power from the AC mains having 110 Vac, 220 Vac or 380 Vac and 50/60 Hz and converts the AC power to DC power with voltage within the range from 48 Vdc to 300 Vdc, and thereby charges up the rechargeable battery unit 305. Preferably the rechargeable battery unit 305 has a voltage of 60 Vdc. The DC power supply 300 further comprises a DC-to-DC converter 304 and the rechargeable battery unit 305 couples to an input terminal of the DC-to-DC converter 304. Further DC power packs 306 external to the DC power supply 300 are also provided to be charged by the DC power supply 300 via the DC-to-DC converter 304. The DC power supply 300 still further includes a DC output terminal 309 disposed on the housing 307 for outputting the DC power stored in the battery unit 305. The DC output terminal 309 is connectable to a detachable DC-to-AC power inverter 303. The AC-to-DC converter 302 converts the mains to a first-voltage DC power having a voltage ranging from 48 Vdc to 300 Vdc for charging the battery unit 305. In this embodiment, the rechargeable battery unit 305 is of a capacity within a range of 0.1 kwh to 10 kwh. The battery unit 305 provides a DC source to the detachable DC-to-AC inverter 303 and the inverter 303 converts the DC source to AC output of 230 Vac, or 110 Vac, at 50 Hz which is suitable for operating a 2 kW AC power tool or other device running on AC.

Accordingly, the DC power supply 300 is designed to allow a user to have a rated DC power suitable for charging the DC power packs 306 and to provide DC power source for powering up DC power tools or other devices running on DC.

Advantageously, the DC power supply 300 of present invention provides an uninterrupted DC power source for the detachable DC-to-AC inverter 303 when the DC power supply 300 is connected to the detachable DC-to-AC inverter 303 connected an AC load.

More specifically, the portable DC power supply of the present invention further provides DC outlets/output ports for connecting and providing power to DC electric applications and other electronic devices, and charging DC power packs depending on the amount of DC power required by the applications. The converters 302 and 304 work together (under command of the controller, not shown) to condition the supply provided to DC loads via the DC outlets/output ports. The controller receives various current and voltage measurements from different parts of the circuit, in order to perform its function. The skilled reader is familiar with these requirements and they will not be described further herein. The power supply 300 is configured via the controller to an operation mode suitable for the above-mentioned applications (i.e. providing power to DC loads or charging DC power packs 306).

In this embodiment, the DC-to-DC converter 304 is a bi-directional dc-dc converter capable of transferring DC power in either direction (i.e. to or from the DC power pack 306) on power bus. Specifically, the DC power supply assembly 300 is set in normal operation mode when no AC load driven from the detachable DC-to-AC inverter 303 or the power supply 300 being not connected to the detachable DC-to-AC inverter 303 at all is detected. In the normal operation mode, the DC power supply 300 provides a forward parallel path for the charges flowing from the built-in battery unit 305 to DC-to-DC converter 304—DC power pack 306 branch and to DC power tool branch, as illustrated in FIG. 3a path C. In this mode, the DC-to-DC converter 304 converts the first-voltage DC power from the rechargeable battery unit 305 to a second-voltage DC power to be stored in the one or more DC power packs 306 external to the DC power supply 300. The second-voltage DC power is stored in the one or more DC power packs 306 having voltage ranged from 12 Vdc to 60 Vdc and the one or more DC power packs 306 are suitable for use in battery-driven cordless DC power tool. In this mode, the battery unit 305 can also be a DC power source for corded DC power tool when it is connected to the DC outlet 311.

On the other hand, as shown in FIG. 3a path D when the AC power tool is connected to the detachable DC-to-AC inverter 303 which is connected to the DC power supply 300 and an AC load is detected, the DC power supply 300 is automatically switched to from the normal DC mode to discharging mode allowing the AC output from the detachable DC-to-AC power inverter 303 to power up the AC electric power tool. In this discharging mode, the DC power supply 300 is configured to provide a reversed series path (thereby disable the forward path of charging the DC power pack 306 and driving the DC power tool) for current to leave the DC power pack 306 (if it is connected to the DC power supply 300) and the rechargeable battery unit 305 via the DC-to-DC converter 304 and the detachable DC-to-AC power inverter 303, and thereby energizes the AC power tool. Regardless of the presence of the DC power tool connecting to the DC power supply 300, the AC power tool is prioritized to draw combined DC power of the first-voltage DC power from the rechargeable battery unit 305 and the second-voltage DC power from the DC power pack 306 to the detachable DC-to-AC inverter 303 generating the AC output for powering up the AC power tool.

The controller is configured to control the operation mode as described above, based on detecting presence of the AC load, such that the converter 304 is selectively operable to generate and/or condition DC power at DC load ports or condition AC power at AC load port.

In another exemplary DC power supply 300 according to the present invention as shown in FIG. 3b, the housing 307 of the DC power supply 300 includes a first DC outlet 311 for connecting to corded DC power tool and supplying the first-voltage DC power from the rechargeable battery unit 305 to the corded DC power tool. The corded DC power tool may be a sander, table saw, miter saw, jig saw, angle grinder, electric router, electric hammer, drill, etc. Of course other electric tools can also be used, but are not described in detail due to limit of the text.

In yet another exemplary power supply assembly, the housing 307 further includes a second DC outlet 312 such as USB port for connecting to other electric tools and supplying the first-voltage DC power from the AC-to-DC converter 302 to the other electric tools. The other electric tools may include but not limited to the portable/handheld electronic devices, tablets, laptop, smartphone, etc.

In still further exemplary power supply assembly, the housing 307 further includes a DC output port 313 for receiving and charging further rechargeable battery packs 306 by the second-voltage DC power via the DC-to-DC converter 304.

The rechargeable battery unit 305 may be hard-wiredly coupled between the AC-to-DC converter 302 and the DC output terminal 309 or the battery unit 305 may be removably connected to both the AC-to-DC converter 302 and the DC output terminal 309. Advantageously, if the battery unit 305 becomes exhausted and no longer keeps its charge, it can be readily replaced by a new one when the battery unit 305 is removably connected to the AC-to-DC converter 302 and the DC output terminal 309.

In a yet further aspect of the present invention, it provides a kit that includes the DC power supply 300 and one or more rechargeable battery packs 306, which can be recharged by the DC power supply 300. Preferably the rechargeable battery packs 306 are for use in the battery-driven cordless DC power tools. The DC battery-driven cordless power tool may be a sander, table saw, miter saw, jig saw, angle grinder, electric router, electric hammer, drill, etc. Of course other power tools can also be used, but are not described in detail due to limit of the text. This kit provides power source to cordless DC power tool.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

1. A portable power supply operated on AC mains having a mains input, the portable power supply comprising:
an AC-to-DC converter coupled between the mains input and a rechargeable battery unit;
a DC-to-DC converter, wherein the rechargeable battery unit couples to an input of the DC-to-DC converter;
a power inverter for converting direct current (DC) into alternating current (AC),
a housing for enclosing the AC-to-DC converter, the rechargeable battery unit, the DC-to-DC converter and the power inverter; and
an AC outlet disposed on the housing;
wherein the rechargeable battery unit is connected between the AC-to-DC converter and the power inverter; a first-voltage DC power converted from the AC mains via the AC-to-DC converter is stored in the rechargeable battery unit, thereby supplies the first-voltage DC power to the power inverter and such that in use, the first-voltage DC power from the rechargeable battery unit is converted to AC output available at the AC outlet of the portable power supply by the power inverter.

2. The portable power supply as claimed in claim 1, wherein the DC-to-DC converter is bi-directional and converts the first-voltage DC power to a second-voltage DC power for charging one or more battery packs.

3. The portable power supply as claimed in claim 2, wherein the power supply is operable and switchable between a normal DC operation mode in which the first-voltage DC power is supplied to the bi-directional DC-to-DC converter converting the first-voltage DC power to the second-voltage DC power for charging the one or more battery packs, and a discharging mode in which the second-voltage DC power stored in the one or more battery packs and the first-voltage DC power stored in the rechargeable battery unit are released to an AC load connected to the power inverter.

4. The portable power supply as claimed in claim 3, wherein the power supply is configured to the discharging mode when the AC load is connected to the AC outlet, or to the normal DC operation mode when the AC load is not connected to the AC outlet.

5. The portable power supply as claimed in claim 1, wherein the AC-to-DC converter is a DC charger for charging the rechargeable battery unit.

6. The portable power supply as claimed in claim 1, wherein the housing includes a first DC outlet for connecting to DC load and supplying the first-voltage DC power from the rechargeable battery unit to the DC load.

7. The portable power supply as claimed in claim 6, wherein the housing includes a second DC outlet for connecting to other electric device and supplying the first-voltage DC power from the AC-to-DC converter to said other electric device.

8. (canceled)

9. The portable power supply as claimed in claim 7, wherein the other electric device is portable electronic device such as mobile phones.

10-15. (canceled)

16. The portable power supply as claimed in clam 1, wherein the rechargeable battery unit is removably connected between the AC-to-DC converter and the power inverter.

17. A kit comprising:
a portable power supply including
an AC-to-DC converter coupled between the mains input and a rechargeable battery unit,
a DC-to-DC converter, wherein the rechargeable battery unit couples to an input of the DC-to-DC converter,
a power inverter for converting direct current (DC) into alternating current (AC),
a housing for enclosing the AC-to-DC converter, the rechargeable battery unit, the DC-to-DC converter and the power inverter, and
an AC outlet disposed on the housing,
wherein the rechargeable battery unit is connected between the AC-to-DC converter and the power inverter; a first-voltage DC power converted from the AC mains via the AC-to-DC converter is stored in the rechargeable battery unit, thereby supplies the first-voltage DC power to the power inverter and such that in use, the first-voltage DC power from the rechargeable battery unit is converted to AC output available at the AC outlet of the portable power supply by the power inverter; and
one or more rechargeable battery packs.

18. The kit as claimed in claim 17 wherein the one or more rechargeable battery packs are used in DC power tools.

19. (canceled)

20. A portable direct current (DC) power supply operated on AC mains having a mains input, the portable DC power supply comprising:
an AC-to-DC converter coupled between the mains input and a rechargeable battery unit;
a DC-to-DC converter, wherein the rechargeable battery unit couples to an input of the DC-to-DC converter;
a housing for enclosing the AC-to-DC converter, the rechargeable battery unit and the DC-to-DC converter; and
a DC output terminal disposed on the housing outputting first-voltage DC power from the rechargeable battery unit;
wherein the DC output terminal is connectable to a detachable DC-to-AC power inverter and supplies the first-voltage DC power to the power inverter and such that when the DC-to-AC power inverter is connected to the DC power supply, the first-voltage DC power from the DC output terminal is converted to AC output via the detachable power inverter.

21. The portable DC power supply as claimed in claim 20, wherein the DC-to-DC converter is bi-directional and converts the first-voltage DC power to a second-voltage DC power for charging one or more battery packs.

22. The portable DC power supply as claimed in claim 21, wherein the power supply is operable and switchable between a normal DC operation mode in which the first-voltage DC power is supplied to the bi-directional DC-to-DC converter converting the first-voltage DC power to the second-voltage DC power for charging the one or more battery packs, and a discharging mode in which the second-voltage DC power stored in the one or more battery packs and the first-voltage DC power stored in the rechargeable battery unit are released to an AC load connected to the detachable DC-to-AC power inverter connected to the DC output terminal.

23-25. (canceled)

26. The DC power supply as claimed in claim 20, wherein the AC-to-DC converter is a DC charger for charging the rechargeable battery unit.

27. The DC power supply as claimed in claim 20, wherein the housing includes a first DC outlet for connecting to DC load and supplying the first-voltage DC power from the rechargeable battery unit to the DC load.

28. The DC power supply as claimed in claim 20, wherein the housing includes a second DC outlet for connecting to other electric device and supplying the first-voltage DC power from the AC-to-DC converter to the other electric device.

29. The DC power supply as claimed in claim 27, wherein the DC load is DC power tool.

30. The DC power supply as claimed in claim 28, wherein the other electric device is portable electronic devices such as mobile phones.

31-34. (canceled)

35. The DC power supply as claimed in claim 20, wherein the rechargeable battery unit is removably connected between the AC-to-DC converter and the DC output terminal.

36-39. (canceled)
